(19) United States
(12) Patent Application Publication
(10) Pub. No.: US 2024/0402073 A1
(43) Pub. Date: Dec. 5, 2024

(54) ELECTRODE DESIGN FOR SURFACE ENHANCED INFRARED SPECTROSCOPY

(71) Applicant: Wisconsin Alumni Research Foundation, Madison, WI (US)

(72) Inventors: Martin T. Zanni, Madison, WI (US); Nan Yang, Madison, WI (US); Matthew Ryan, Madison, WI (US)

(21) Appl. No.: 18/731,954

(22) Filed: Jun. 3, 2024

Related U.S. Application Data
(60) Provisional application No. 63/471,183, filed on Jun. 5, 2023.

(51) Int. Cl. G01N 21/05; G01N 21/3577

(52) U.S. Cl. CPC G01N 21/05; G01N 21/3577

(57) ABSTRACT

A flow cell working electrode is provided. The electrode may include a substrate. The electrode may include a conductive electrode layer contacting the substrate. The electrode may include an electrically resistive layer contacting the conductive electrode layer such that the conductive electrode layer is positioned between the substrate and the electrically resistive layer, the electrically resistive layer having an electrically resistive thickness tailored to reduce electrical conductivity across the electrically resistive layer but to allow an electric field associated with a voltage applied to the conductive electrode layer to be felt across the electrically resistive layer. The electrode may include a macroscopically non-conductive plasmonic metal layer contacting the electrically resistive layer such that the electrically resistive layer is positioned between the conductive electrode layer and the macroscopically non-conductive plasmonic metal layer.

### CROSS-REFERENCE TO RELATED APPLICATION

This application claims priority to U.S. Provisional Patent Application No. 63/471,183, filed Jun. 5, 2023, which is incorporated herein by reference in its entirety for all purposes.

### STATEMENT REGARDING FEDERALLY SPONSORED RESEARCH

This invention was made with government support under GM135936 awarded by the National Institutes of Health. The government has certain rights in the invention.

### BACKGROUND

The structure and dynamics of molecules under an applied electric field is of fundamental interest to a wide range of disciplines spanning electrochemistry to biophysics. In electrochemical and electrocatalytic cells, reactions occur because of the electric field at the electrode interface, which is often enhanced by the presence of electric double layer near the surface. The dynamics of the reactants and solvents at the interface also respond to different electric field strengths. In biology, electric fields across membranes are generated by two sets of electric double layers, one on each side. That field is sensed by the proteins within the membrane, altering their structure and triggering their function. It is well-documented that electric fields alter molecular structure and orientation at interfaces, but the impact of electric fields on dynamics of molecules is largely unmeasured.

Dynamics under an applied field are an understudied topic largely because there are not many experimental techniques capable of doing so. There are very few molecules at an interface, as compared to the bulk, and so sensitivity is a limiting factor. Useful techniques for interfacial structure determination include sum frequency generation (SFG), surface enhanced Raman (SERS), infrared reflection absorption (IRAS), and surface/plasmonically enhanced infrared spectroscopy (SEIRA), which all provide vibrational spectra and have monolayer sensitivity. SFG spectroscopy relies on a non-linear process to achieve surface sensitivity while the other techniques utilize plasmon enhancement.

In terms of ultrafast dynamics, Kraack and Hamm pioneered a surface enhanced version of two-dimensional infrared (2DIR) spectroscopy using a thin layer of rough platinum or gold which enhances the monolayer signal to detectable level by common IR detectors. They also put a 0.1 nm Pt layer on top of 5 nm indium tin oxide (ITO) to allow macroscopic conductivity of the electrode and obtained voltage dependent 2DIR spectrum of CO molecules adsorbed to the surface. However, there are fine balances between surface coverage versus average plasmonic metal film thickness, material thickness versus background signal, and conductivity versus lineshape distortions. Thicker metal film provides good coverage, stronger signal and good conductivity but suffers from large background signal and Fano-lineshape distortion. Very thin metal film on ITO provides good conductivity and lower background but causes Fano-lineshape distortions and does not provide as good surface coverage and signal strength.

A need exists for a new electrode design optimized for collecting surface enhanced two-dimensional infrared (SE2DIR) spectra of a monolayer under an applied electric field. It would be beneficial to achieve maximum surface coverage and enhancement. Minimizing background signal would be desirable. An ability to produce SE2DIR spectra with no observable Fano-lineshape distortion is needed.

### SUMMARY

In some aspects, the techniques described herein relate to a flow cell working electrode including a first layered structure, the first layered structure including: a substrate; a conductive electrode layer contacting the substrate; an electrically resistive layer contacting the conductive electrode layer such that the conductive electrode layer is positioned between the substrate and the electrically resistive layer, the electrically resistive layer having an electrically resistive thickness tailored to reduce electrical conductivity across the electrically resistive layer but to allow an electric field associated with a voltage applied to the conductive electrode layer to be felt across the electrically resistive layer; a macroscopically non-conductive plasmonic metal layer contacting the electrically resistive layer such that the electrically resistive layer is positioned between the conductive electrode layer and the macroscopically non-conductive plasmonic metal layer.

In some aspects, the techniques described herein relate to a method of making a flow cell working electrode, the method including: a) depositing a conductive electrode layer onto a substrate; b) depositing an electrically resistive layer onto the conductive electrode layer such that the conductive electrode layer is positioned between the substrate and the electrically resistive layer; c) depositing a macroscopically non-conductive plasmonic metal layer onto the electrically resistive layer such that the electrically resistive layer is positioned between the conductive electrode layer and the macroscopically non-conductive plasmonic metal layer.

In some aspects, the techniques described herein relate to a method of using a flow cell working electrode including sequentially a substrate, a conductive electrode layer, an electrically resistive layer, and a macroscopically non-conductive plasmonic metal layer, the method including: a) applying a first voltage to the conductive electrode layer; b) during the applying of step a), acquiring an infrared spectrum of molecules of interest present at a surface of the macroscopically non-conductive plasmonic metal layer, the molecules of interest experiencing a first electric field associated with the first voltage; c) applying a second voltage to the conductive electrode layer, wherein the second voltage is different than the first voltage; d) during the applying of step c), acquiring an infrared spectrum of the molecules of interest, the molecules of interest experiencing a second electric field associated with the second voltage; e) generate a report including field-dependent infrared spectra, wherein the field-dependent infrared spectra have a sufficiently low background signal to resolve an OH stretching mode, a CO stretching mode, a CN stretching mode, or a CH stretching mode.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The disclosure and the following detailed description of certain aspects thereof may be understood by reference to the following figures:

FIG. 1 is a schematic of a flow cell working electrode and an electrode pair, in accordance with aspects of the present disclosure.

FIG. 2 is a schematic of a flow cell, in accordance with aspects of the present disclosure.

FIG. 3 is a schematic of a spectroscopic system, in accordance with aspects of the present disclosure.

FIG. 4 is a flowchart of a method, in accordance with aspects of the present disclosure.

FIG. 5 is a flowchart of a method, in accordance with aspects of the present disclosure.

FIG. 6 illustrates the metallic patterns used on laser windows serving as electrodes, as described in Example 1.

FIG. 7 is a cross-sectional view of the electrochemical cell assembly, as described in Example 1. W.E., R.E., C.E. stand for working, reference and counter electrode, respectively. The wavelets represent the laser pulses used in a 2DIR experiment in the pump-probe geometry.

FIG. 8 is a series of AFM images of the rough gold surface at different scales, as described in Example 1.

FIG. 9 is a series of SEM images of the rough gold surface at different scales, as described in Example 1.

FIG. 10 is a cross-sectional HR-TEM image of the ITO-Al₂O₃ thin films on CaF₂ substrate, as described in Example 1.

FIG. 11 is a pair of plots of 2DIR background signal intensity from various resistance ITO thin films, as described in Example 1. The resistance is measured across 25 mm. The black lines are drawn as a visual guide. One example of the actual background signal spectrum is shown in FIG. 16.

FIG. 12 a plot of resistance of ITO thin films with respect to deposition time, RF sputtering power, and thickness, as described in Example 1.

FIG. 13 is FTIR spectrum of 4-MBA monolayer on 3 nm plasmonic gold thin film, with and without the Al₂O₃ resistive layer, as described in Example 1.

FIG. 14 is a pair of 2DIR spectra of 4-MBN monolayer on 3 nm gold thin film with (top) and without (bottom) the Al₂O₃ resistive layer in addition to the ITO base, as described in Example 1.

FIG. 15 is a 2DIR plot of diagonal background signal observed on a thicker (n=5 nm) gold layer, as described in Example 1.

FIG. 16 is a 2DIR plot of background signal from the ITO thin film, as described in Example 1.

FIG. 17 is a plot of center frequency of the CN stretching mode of the 4-MBN monolayer under various applied voltages relative to the Ag/AgCl reference electrode in various solutions, as described in Example 1.

FIG. 18 is a plot of diagonal slices of the surface enhanced 2DIR spectrum of the 4-MBN monolayer under various applied voltages, as described in Example 1.

FIG. 19 is a relative transition dipole of the 4-MBN monolayer under different applied voltages, as described in Example 1.

FIG. 20 is a surface enhanced FTIR spectrum of the 4-MBN monolayer attached to two different types of plasmonic surfaces, as described in Example 1.

FIG. 21 is a plot of diagonal slices of the surface enhanced 2DIR spectrum of the 4-MBAME monolayer in 10 mM KCl D₂O solution under various voltages, as described in Example 1.

FIG. 22 is a surface enhanced 2DIR spectrum of 4-MBAME monolayer in 10 mM KCl D₂O solution at 0 ps waiting time, as described in Example 1.

FIG. 23 is a surface enhanced 2DIR spectrum of 4-MBAME monolayer in 10 mM KCl D₂O solution at 6 ps waiting time, as described in Example 1.

FIG. 24 is a surface enhanced 2DIR spectrum of 4-MBAME monolayer in 10 mM KCl D₂O solution at 15 ps waiting time, as described in Example 1.

FIG. 25 is a plot of vibrational lifetime of the CO stretching mode, as described in Example 1.

FIG. 26 is a plot of lifetime of the CH stretching mode, as described in Example 1.

FIG. 27 is a plot of cross peak intensity over time normalized against the CH stretching mode intensity, as described in Example 1.

FIG. 28 is an image of an exemplary non-conductive pattern of engineered plasmonic nanostructures.

FIG. 29 is an image of an exemplary plasmonic nanostructure.

### DETAILED DESCRIPTION

Before the present invention is described in further detail, it is to be understood that the invention is not limited to the particular embodiments described. It is also understood that the terminology used herein is for the purpose of describing particular embodiments only and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

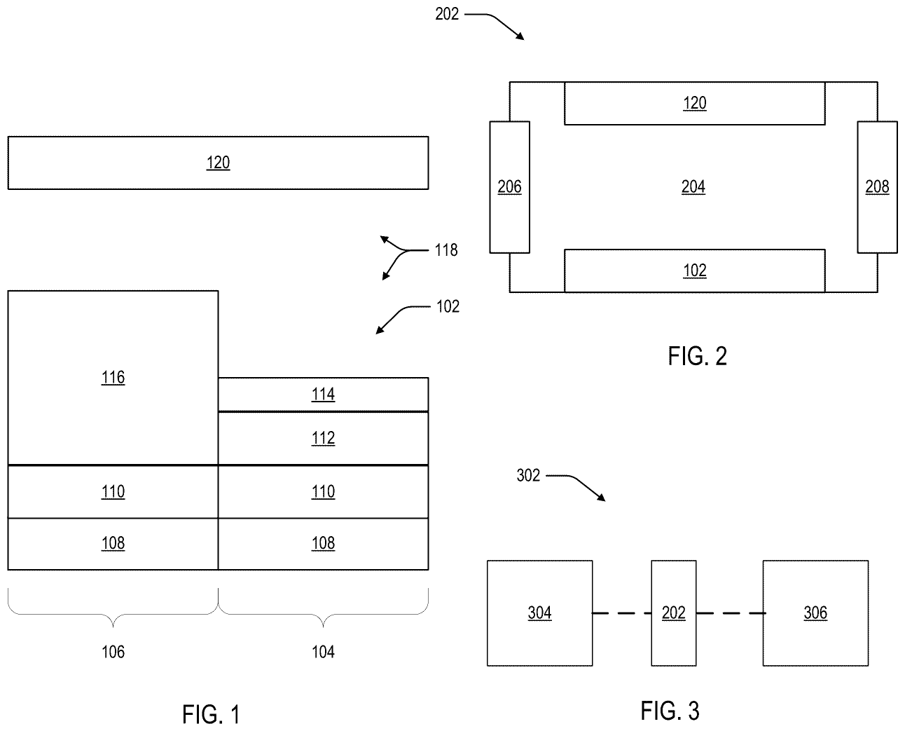

Referring now to FIG. 1, the present disclosure provides a flow cell working electrode 102. The flow cell working electrode 102 includes a first layered structure 104. In some cases, the flow cell working electrode 102 includes a second layered structure 106 laterally adjacent to or surrounding the first layered structure 104.

The first layered structure 104 includes a substrate 108, a conductive electrode layer 110, an electrically resistive layer 112, and a macroscopically non-conductive plasmonic metal layer 114.

The electrically resistive layer 112 can have an electrically resistive layer thickness of between 3 nm and 5 nm. The electrically resistive layer can be composed of an electrically resistive layer material selected from the group consisting of Al₂O₃, SiO₂, Te₂O₅, silicon nitride (Si₃N₄), and combinations thereof. In certain specific instances, Al₂O₃ is a beneficial electrically resistive layer material.

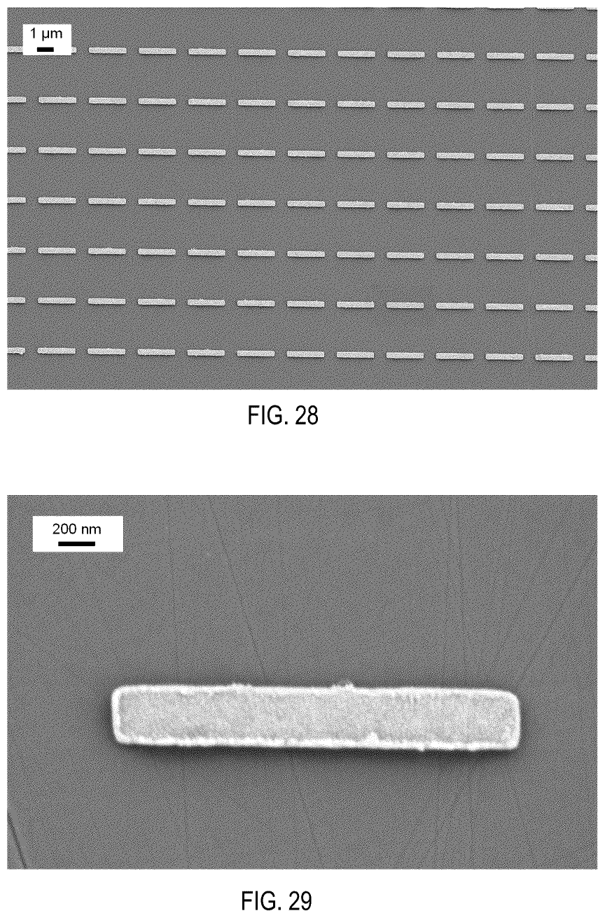

The macroscopically non-conductive plasmonic metal layer 114 can have a plasmonic metal layer thickness of between 1 nm and 8 nm, between 1 nm and 6 nm, or between 2 nm and 4 nm. The macroscopically non-conductive plasmonic metal layer 114 is composed of a macroscopically non-conductive plasmonic metal layer material selected from the group consisting of Au, Pt, Ag, and combinations thereof. In some cases, the macroscopically non-conductive plasmonic metal layer material is Au. In some cases, the macroscopically non-conductive plasmonic metal layer material is Pt. In some cases, the macroscopically non-conductive plasmonic metal layer 114 is a non-conductive pattern of engineered plasmonic nanostructures (e.g., nanoantennae similar to those used in Adato et al., PNAS, 106(46); 19227-19232, which is incorporated herein in its entirety by reference for all purposes). These nanostructures could have different thicknesses than those described above, for example, thicknesses of between 10 nm and 200 nm. A skilled artisan will recognize that the precise structure of these nanostructures can vary. Images of exemplary nanostructures are shown in FIGS. 28 and 29, with respective scale bars.

Applying the voltage to the conductive electrode layer 110 produces an electric-field-applied surface. Voltages applied to the conductive electrode layer produce an electric field that is felt at a surface of the macroscopically non-conductive plasmonic metal layer 114. In some cases, the voltage itself is applied to the conductive electrode layer, thereby producing the electric-field-applied surface by producing the electric field that is felt at the surface of the macroscopically non-conductive plasmonic metal layer 114.

Applying light (e.g., infrared light) from a coherent or incoherent light source to the conductive electrode layer 110 provides a surface-enhanced two-dimensional infrared or Fourier transform infrared (FTIR) spectroscopy surface on the macroscopically non-conductive plasmonic metal layer 114. In some cases, the light itself is incident the macroscopically non-conductive plasmonic metal layer 114. In some cases, at least one beam of infrared light having a frequency of between 1500 cm⁻¹ and 3500⁻¹ is incident the macroscopically non-conductive plasmonic metal layer 114.

The conductive electrode layer 110 can have a conductive electrode layer thickness of between 5 nm and 100 nm. In some cases, the conductive electrode layer 110 is a semiconductor material layer. In some cases, the conductive electrode layer 110 has an amorphous crystalline structure. The conductive electrode layer 110 can be composted of a conductive electrode layer material selected from the group consisting of indium tin oxide, zinc oxide, doped zinc oxide, fluorine doped tin oxide, titanium dioxide, carbon nanotubes, conductive polymers, and combinations thereof. In some cases, the conductive electrode layer material is or comprises indium tin oxide.

The substrate 108 can have a thickness of between 0.1 mm and 5 mm. The substrate 108 can generally be composed of any material that is adequately transmissive with sufficient structural integrity and adequately low background signal. The substrate can be composed of a substrate material selected from the group consisting of CaF₂, BaF₂, CsI, CdTe, ZnSe, sapphire, Si, Ge, and combinations thereof. In some cases, the substrate 108 has a crystalline structure.

The flow cell working electrode 102 or the first layered portion 104 can have an optical density of between 0.0001 and 0.05 over the wavelength range of between 2500 nm and 10,000 nm. This optical density is dependent on layer thickness, as would be appreciated by a skilled artisan.

In some cases, the flow cell working electrode 102 or the first layered structure 104 transmits at least 50% of light of a predetermined wavelength. The flow cell working electrode 102 or the first layered structure 104 transmits at least 60%, at least 70%, at least 75%, at least 80%, at least 90%, or at least 95% of the light of the predetermined wavelength. The flow cell working electrode 102 or the first layered structure 104 can be transparent to the light of the predetermined wavelength. The predetermined wavelength can be between 2500 nm and 10,000 nm.

The optional second layered structure 106 includes the substrate 108, the conductive electrode layer 110, and a conductive metal layer 116. In some cases, the conductive metal layer 116 contacts the macroscopically non-conductive plasmonic metal layer 114. The conductive metal layer 116 can have a thickness of between 10 nm and 1 μm. The conductive metal layer 116 can be composed of a conductive metal layer material selected from the group consisting of Au, Pt, Ag, Cr, Ni, Al, Ti, Cu, and combinations thereof.

In some cases, the present disclosure provides an electrode pair 118 comprising the flow cell working electrode 102 and a counter electrode 120.

Referring to FIG. 2, a flow cell 202 is shown. The flow cell 202 includes a detection channel 204 in fluidic communication with an inlet 206 and an outlet 208. The detection channel 204 includes at least one flow cell working electrode 102 oriented to sense molecules of interest present at a surface (e.g., a monolayer or a thin layer of a fluid) of the detection channel 204. The flow cell 202 can include the counter electrode 120 positioned within the detection channel 204. The flow cell 202 can include various electrical leads (not illustrated) as would be appreciated by a skilled artisan. The flow cell 202 can include various fluidic affordances, such as ports for accessing the detection channel 204 for various purposes, such as including a reference electrode within the detection channel 204 (not illustrated), or threadings, seals, o-rings, or other fluid containment and/or routing tools for the purpose of maintaining fluidic routing capable of receiving liquids at the inlet 206, subsequently moving them through the detection channel 204, and finally expelling them from the outlet 208.

Referring to FIG. 3, a spectroscopic system 302 is shown. The spectroscopic system 302 includes a light source 304, an optical detector 306, and the flow cell 202 operably positioned in an optical path between the light source 304 and the optical detector 306. The spectroscopic system 302 includes the necessary electronics and computing hardware and software, as would be appreciated by a skilled artisan (not illustrated). Multiple different light sources producing multiple beams of light may be included in spectroscopic system 302. An exemplary spectroscopic system 302 is described below in Example 1, though others are contemplated as would be appreciated by a spectroscopist having ordinary skill in the art. In some cases, the spectroscopic system 302 is arranged in a transmission geometry, though others are contemplated. In some cases, the spectroscopic system 302 can be a 2DIR system, operating at 1 kHz, 100 kHz, or another operable frequency. In some cases, the spectroscopic system 302 can be a commercial FTIR system. Alternatives could be fully time-domain 2D IR spectroscopic systems, transient absorption spectroscopic systems, or other commercial or home-built FTIR or linear IR systems. Any repetition rate can be used.

Operable positioning of the flow cell 202 involves fluidic connection, in order to facilitate movement of liquid through the detection channel 204, as well as electronic connection, in order to facilitate application of various electric fields to the flow cell working electrode 102, counter electrode 120, other electrode, or other electrically active component of flow cell 202.

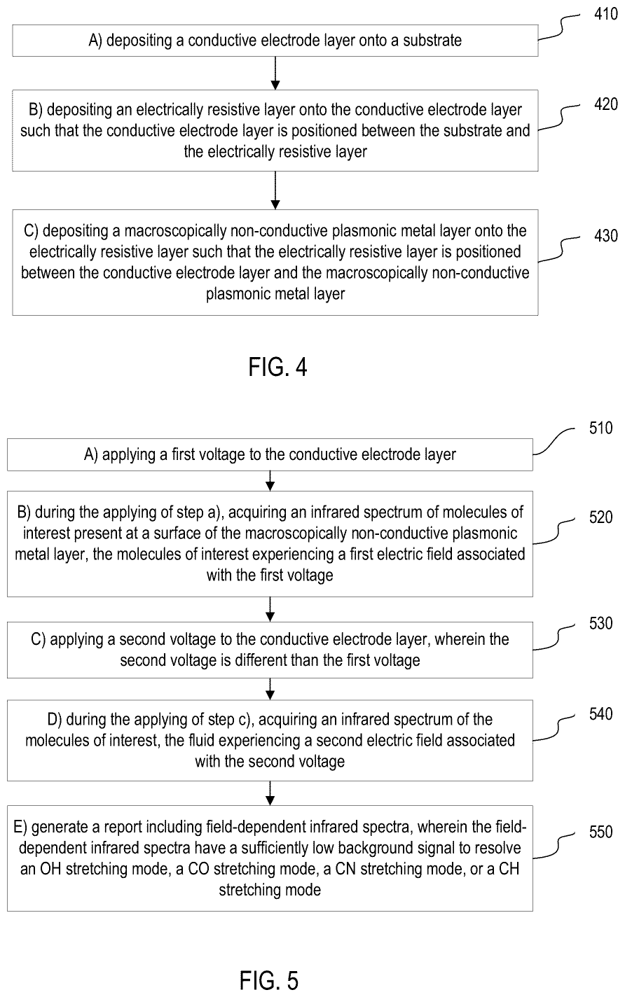

Referring to FIG. 4, the present disclosure provides a method of making a flow cell working electrode. The method includes: at process block 410, a) depositing a conductive electrode layer onto a substrate; at process block 420, b) depositing an electrically resistive layer onto the conductive electrode layer such that the conductive electrode layer is positioned between the substrate and the electrically resistive layer; at process block 430, c) depositing a macroscopically non-conductive plasmonic metal layer onto the electrically resistive layer such that the electrically resistive layer is positioned between the conductive electrode layer and the macroscopically non-conductive plasmonic metal layer. Suitable depositing and masking techniques are exemplified in Example 1, though others are contemplated as would be appreciated by an electrode device engineer having ordinary skill in the art. Thermal evaporation and direct current sputtering could also potentially be used for layer deposition. The patterns could also be made using electron beam lithography.

Referring to FIG. 5, the present disclosure provides a method of using a flow cell working electrode 102. The method includes: at process block 510, a) applying a first voltage to the conductive electrode layer 110; at process block 520, b) during the applying of step a), acquiring an infrared spectrum of molecules of interest present at a surface of the macroscopically non-conductive plasmonic metal layer 114, the molecules of interest experiencing a first electric field associated with the first voltage; at process block 530, c) applying a second voltage to the conductive electrode layer 110, wherein the second voltage is different than the first voltage; at process block 540, d) during the applying of step c), acquiring an infrared spectrum of the molecules of interest, the molecules of interest experiencing a second electric field associated with the second voltage; at process block 550, e) generate a report including field-dependent infrared spectra, wherein the field-dependent infrared spectra have a sufficiently low background signal to resolve an OH stretching mode, a CO stretching mode, a CN stretching mode, or a CH stretching mode. In certain cases, the acquiring of steps b) and d) involve performing SE2DIR spectroscopy. In certain cases, the report includes voltage-dependent SE2DIR spectra.

### EXAMPLES

### Example 1

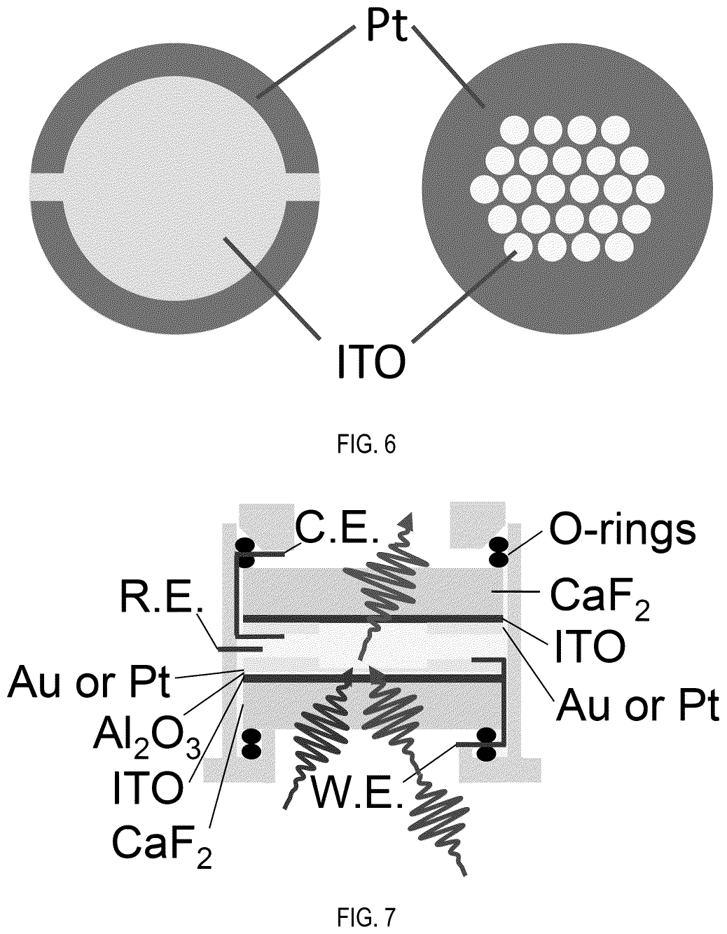

We designed an electrochemical flow cell that was capable of acquiring FTIR and 2DIR spectrum of the fluid as well as the interface in both transmission and reflection modes. The assembly included two CaF₂ windows (25 mm diameter 2 mm thickness, Crystran) both coated with 10-20 nm of indium tin oxide (ITO) and 100 nm patterned platinum or gold as electrodes and for detection of interface signal a plasmonic rough gold/platinum layer can be coated to enhance the weak signal. The 100 nm metallic layers were patterned with metal masks or photolithography to allow IR light transmission through the holes (FIG. 6). The ITO layer served as an IR transparent conductor and the Pt/Au layer reduced the contact resistance with the ITO and formed better contact with external wirings. One of the windows was coated with a 3-5 nm Al₂O₃ resistive layer and a 3 nm rough Au or Pt plasmonic layer and served as the working electrode for surface enhanced spectroscopy. The windows were connected to the voltage source via 25-micron thick Pt foils. Alternatively, a counter electrode can be added, such as a Pt mini-electrode (E-DAQ), that is inserted from the side of the electrochemical flow cell as would be appreciated by a skilled artisan. Pt was chosen because it is chemically inert and has high resistance to electrochemical corrosion. The windows were separated by 12 or 25-micron Teflon semicircular spacers, the gaps were aligned to the flow port positions to allow best flow between the windows. The flow characteristics were tested by filling the cell with water and flow dyed water through with a peristaltic pump (Intllab), the fluid between the window is displaced within 30 s at high flow setting (5-10 mL/min). The cell body was machined out of polyether-ether ketone (PEEK) plastic, ports for flow tubes and reference electrode are made to be compatible with Spex VapLock fittings (Cole-Parmer). A 2 mm outer diameter Ag/AgCl leakless reference electrode (E-DAQ) was used, the leakless design is convenient for measurements in various solutions of different ion species and concentrations. The electrochemical cell can be run in two or three electrode modes with a computer controlled potentiostat (Iorodeo) and custom control codes.

The CaF₂ windows were cleaned with oxygen plasma for 2 minutes before deposition. A 5-10 nm ITO layer was deposited via radiofrequency sputtering (modified CVC 601 sputterer). A 4-inch diameter target of 90-10 mixture (by weight) of indium oxide and tin oxide was used under 10 mTorr argon and 100 W power. The ITO layer served as the transparent conductive layer, it also served as an adhesion layer between the CaF₂ and Pt or Au or Al₂O₃ layers. The Pt/Au thin films were then deposited with an electron beam evaporator (Fabricated by Wisconsin Centers for nanoscale Technology) at 0.5-1 Å/s, the patterning was done with either a machined sheet metal mask or photolithographic process. For the photolithography, a 4-micron thick APOL-LO-3204 negative lift-off resist was spin-coated onto the ITO coated CaF₂ window at 3000 rpm, and baked at 110° C. for 120 s. The resist was then exposed on a Suss MA6 Aligner with 150 mJ/cm² at 350 nm and then post-exposure baked at 110° C. for 120 s. The exposed resist was then developed in 0.26N TMAH for 60 s. 100 nm of Pt or Au was deposited and the lift-off process was done with 1165 remover (n-methyl pyrrolidinone) at 80° C.

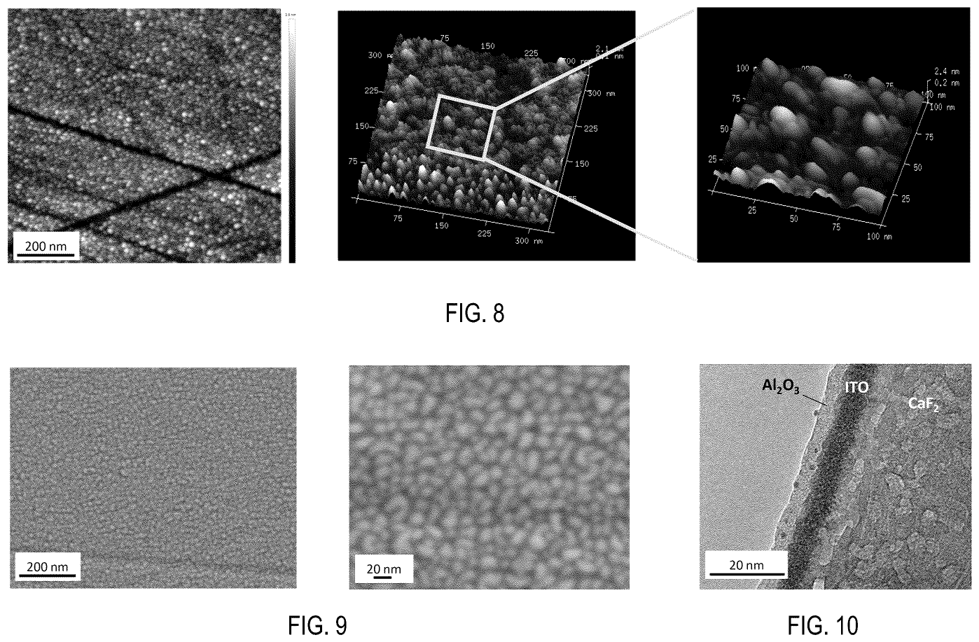

For the working electrode, additional layers were deposited after the metal pattern. A 3-5 nm Al₂O₃ buffer layer was deposited with an electron beam evaporator (Fabricated by Wisconsin Centers for nanoscale Technology) at 0.5 Å/s under 3×10⁻⁵ Torr O₂ and subsequently a 3 nm layer of rough Au or Pt was deposited at 0.1 Å/s. The rough gold surface was characterized with Scanning electron microscope (SEM) and atomic force microscope (AFM) and shown in FIG. 9 and FIG. 8, respectively, the gold islands cover the substrate while leaving gaps such that the film itself is not macroscopically conductive. The gaps between the gold islands are also known to have the best plasmonic enhancement for spectroscopic signals. While the rough gold itself is not macroscopically conductive, the ITO layer provides conductivity through the Al₂O₃ buffer layer so that a voltage can be applied to the interface. More details will be discussed later about this issue. A cross-sectional Transmission electron microscopy (TEM) image of the ITO and Al₂O₃ layers on CaF₂ shown in FIG. 10 depicts the layers of the working electrode. The TEM image suggests that the ITO layer and the Al₂O₃ layer were both amorphous while the CaF₂ substrate was crystalline.

Monolayer sample was prepared by soaking the working electrode in 100 mM 4-mercaptobenzonitrile (4-MBN) or 4-mercaptobenzoicacid methyl ester (4-MBAME) ethanol solution for 12 hours. This procedure is known to form a densely packed monolayer. After the electrochemical flow cell was fully assembled, various solutions could be circulated for measurement of the same monolayer under different electrolyte environments.

All spectroscopic measurements were done in the transmission geometry. For FTIR, a Nicolet iS20 spectrometer (ThermoFisher) was used. For 2DIR measurements, two experimental setups were used: a 1 kHz laser and a 100 kHz laser. The experimental setups are described previously in Farrell et al., Shot-to-Shot 2D IR Spectroscopy at 100 kHz Using a Yb Laser and Custom-Designed Electronics. Opt Express 2020, 28(22), 33584, which is incorporated herein in its entirety by reference. Briefly, ˜150 fs mid-IR pulses centered around 2200 cm⁻¹ from either a DFG and OPA (TOPAS, Light conversion) pumped by a 1 kHz regenerative amplifier (Libra, Coherent) at 900 nm, or a DFG and OPA (Orpheus, Light conversion) pumped by a 100 kHz Yb:KGW regenerative amplifier (Carbide, Coherent) at 1030 nm. The pulses were split into pump and probe pulses and the pump pulses were shaped with a germanium acousto-optic modulator (Isomet). The probe pulse and signal (FIG. 7, purple pulse, i.e., the single topmost pulse) were sent into a monochromator and dispersed on to a 64-pixel MCT array detector for data collection. 2D spectra were generated by scanning the coherence time between the two pump pulses (FIG. 7, red pulse pair, i.e., the pair of pulses positioned to the bottom-right) with a fixed population time between the second pump pulse and the probe pulse (FIG. 7, dark red pulse, i.e., the single pulse positioned to the bottom-left).

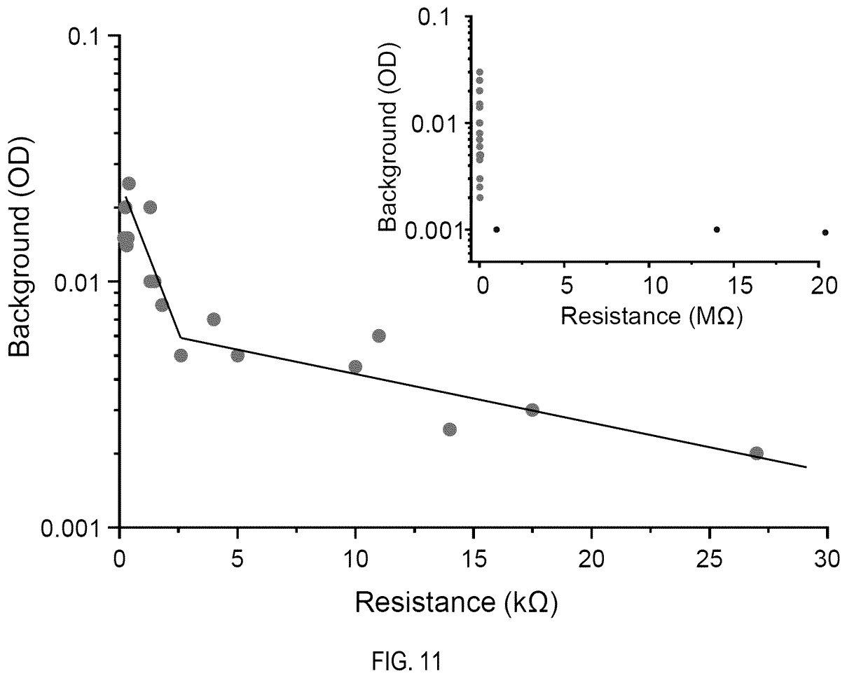

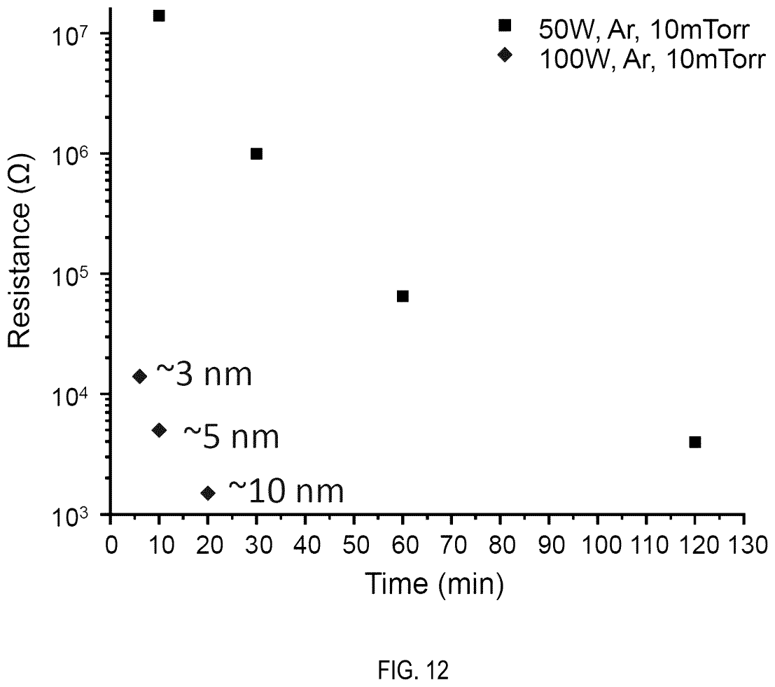

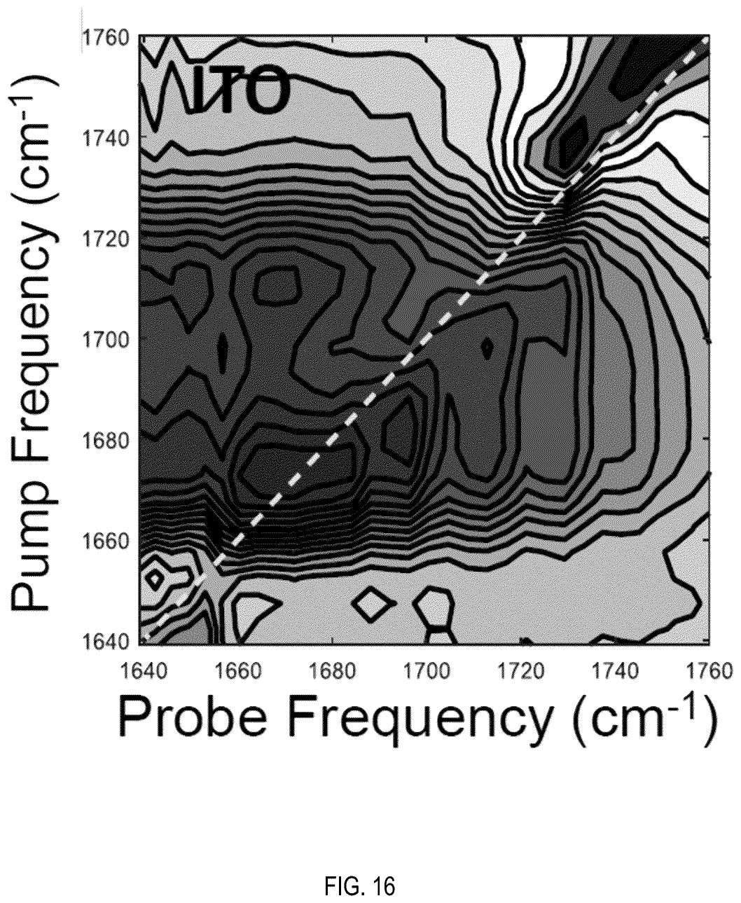

We chose ITO thin film on CaF₂ window as the conductive substrate. We characterized the relationship between the 2DIR background signal (FIG. 16) and intensity as a function of film resistance (FIG. 11). This dataset contains films prepared at various deposition rates and deposition chamber pressure which alters the film topology; however, the trend is robust relative to the resistance regardless of the deposition parameters. The resistance was measured across a 25 mm diameter round substrate with contact points covered with an 80 nm gold film to reduce contact resistance to the probe. There was a clear trend between the resistance and the background signal: the lower the resistance, the higher the background signal. As the resistance increases beyond 1 MΩ, the background signal levels off likely due to the signal being less than the 2DIR spectrometers' noise floor. Another interesting observation is the noise level rapidly drops until the resistance is higher than 5 kΩ and the rate reduces significantly before reaching the noise floor at MΩ resistance. We have thus chosen films ˜10 kΩ which provided good conductivity while having relatively low background signal. One can chose other thicknesses to customize the substrate to fit their needs accordingly, for example, for steady state experiments with very low signal intensity, thinner film with up to 1 MΩ resistance can be more desirable whereas thicker films might be needed when voltage needs to be altered quickly. We have also reported the relationship between deposition rate, deposition time and resulting film resistance (FIG. 12), the relationships are rather non-linear and similar thickness film can have very different resistance depending on the deposition rate likely due to higher rate yielding smoother films. The deposition rate is determined by the radio frequency power of the sputtering machine together with the gas pressure. The specific model used here applies RF power on a 4-inch diameter target about 100 mm below the spinning 1 meter diameter sample holder which lets the substrates pass the deposition area once per minute. Since only the resistance was strongly correlated with the background signal, we chose to use high deposition rate for rapid preparation.

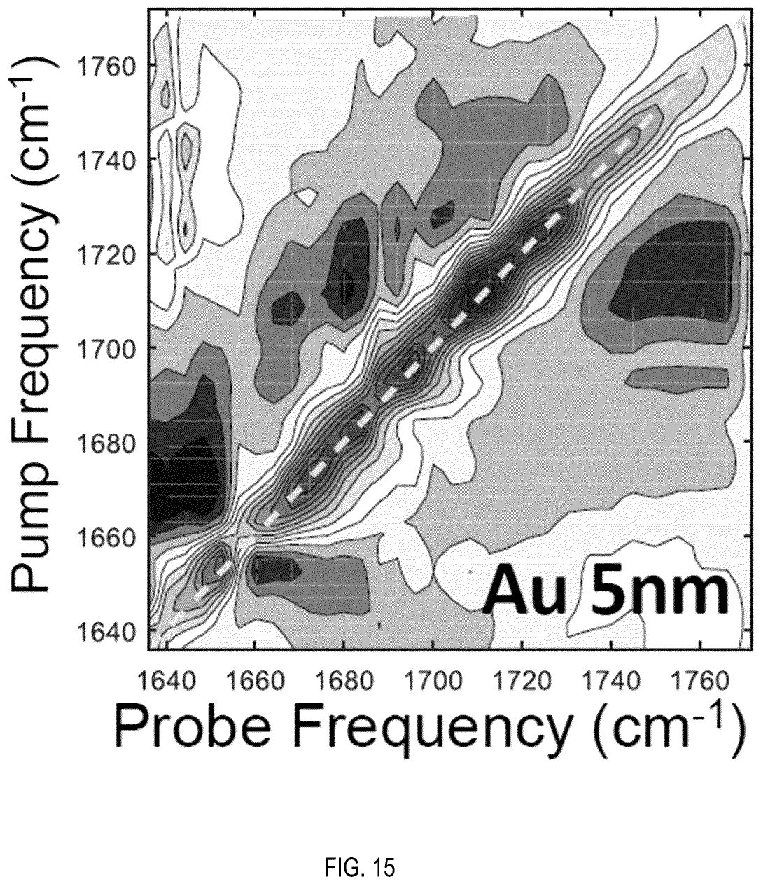

We have tested various thicknesses (1-8 nm) and deposition rates (0.1-3 Å/s) using electron beam evaporator and thermal evaporators. In general, the surface coverage kept improving up to ˜5 nm average thickness where it reached percolation limit depending on the deposition rate, higher deposition rate resulted in film that reaches the percolation limit at thinner thicknesses whereas lower deposition rate resulted in films that could take up to 8 nm before becoming conductive. Once the film reached percolation limit and became conductive, a large background signal showed up (FIG. 15 which is not desirable) thus we chose the thickness of 3 nm which has very high surface coverage (FIG. 8) but is well clear of potential background signal problems. The deposition rate and deposition method (thermal vs. electron-beam) does not significantly influence the signal enhancement; hence either type of evaporator would work.

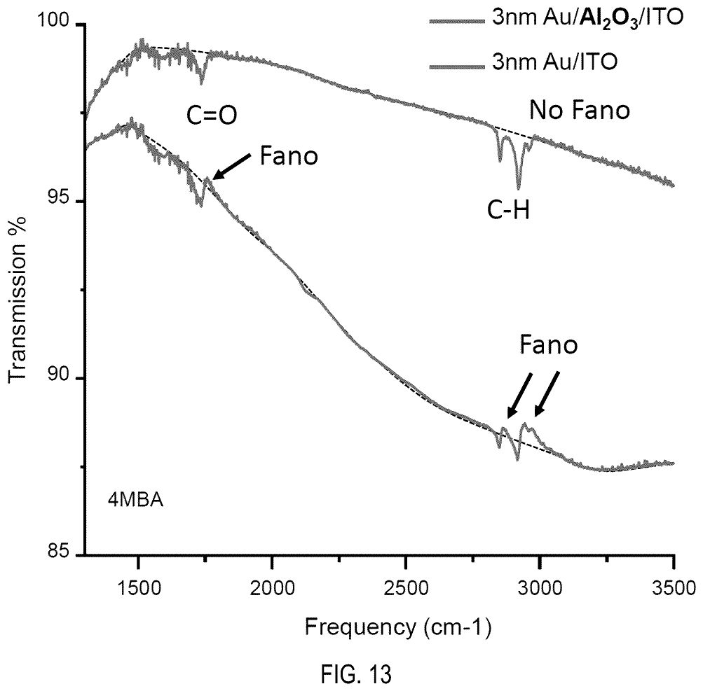

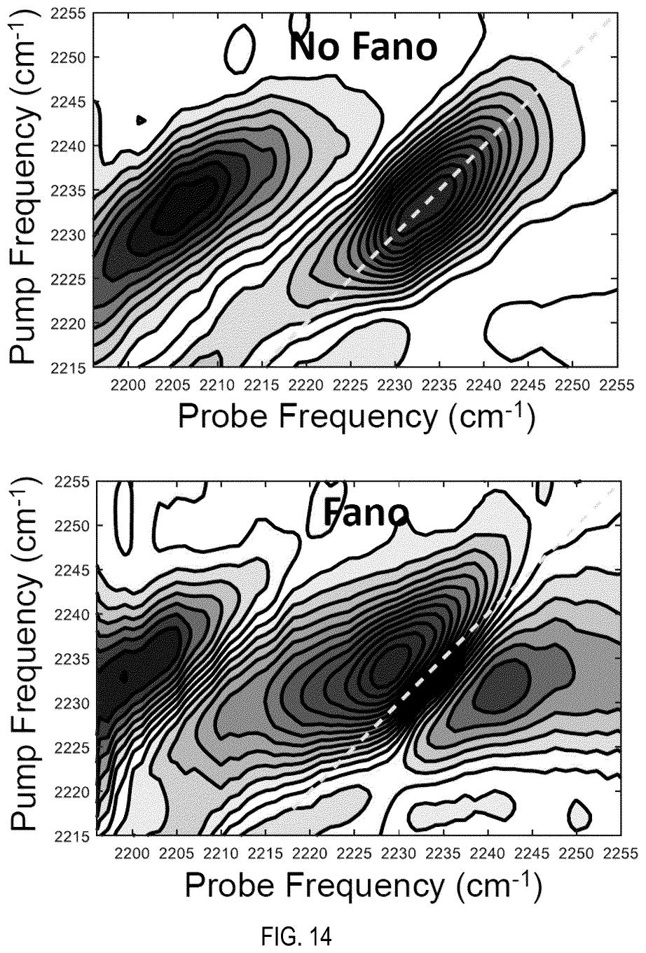

Next step in fabrication was the addition of the plasmonic metal layer. In our first batch of devices, we deposited 3 nm gold directly on the ITO film. However, this caused the gold to become macroscopically conductive, shifting the plasmonic resonance more strongly to the mid IR. That shift caused significant lineshape distortions, with lower transmission on the higher frequency side and derivative lineshapes of the molecular absorptions (gray trace in FIG. 13). The distortion also happens in the 2DIR spectra (FIG. 14 top v. bottom). The lineshape distortion can be corrected locally using a phase shift but is not desirable when accurate lineshape dynamics are under investigation. To prevent the lineshape distortion but still retain conductivity, we added an oxide layer to separate the plasmonic gold from the ITO layer. We explored different oxide films including Al₂O₃ and SiO₂ at various thicknesses from 3-10 nm. The Al₂O₃ provided the best mechanical property and adhesion to gold. The Al₂O₃ film of 3-5 nm thickness prevented the gold from directly contacting the ITO film while still being thin enough ITO allow charge to tunnel through to the gold islands when a voltage was applied to the ITO. Thicker oxide films completely insulated the gold layer and prevented a charge buildup on the gold and hence no electric field at the interface (as confirmed by a lack of Stark shift of surface tethered molecules). We found that a 3-5 nm Al₂O₃ layer between the gold and ITO layers produced a plasmonic electrode that was free of Fano-line shape distortions and had the minimal background signal possible, as seen in the green/top trace in FIG. 13.

We demonstrated our plasmonic electrode by measuring voltage-dependent 2DIR spectra of a 4-mercaptobenzonitrile (4-MBN) monolayer in 10 mM CsCl solution in transmission geometry. The CN stretching mode was observed in the FTIR spectrum at 2230 cm⁻¹ and had an elongated peak in the 2DIR spectrum indicating that it was inhomogeneously broadened (FIG. 14 top).

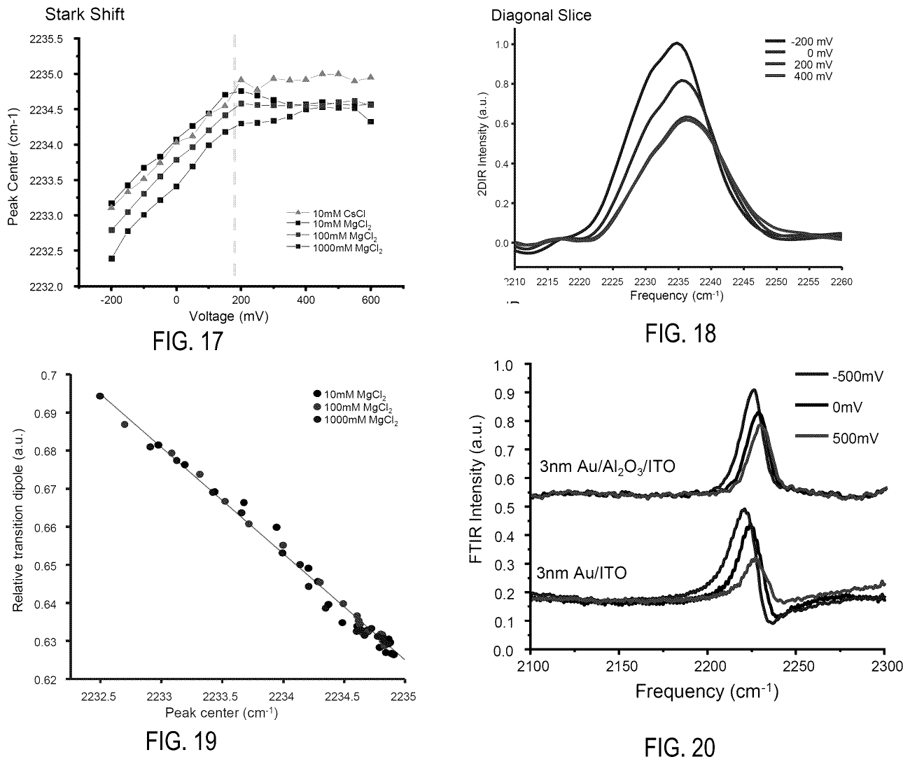

Utilizing the three-electrode setup developed here and the design with and without the Al2O3 layer, we collected FTIR and 2DIR spectra of the 4MBN monolayer under various applied voltages relative to the Ag/AgCl reference electrode in salt solutions. From the diagonal slices of 2DIR spectra, a nearly linear Stark shift was observed below 1000 mV with a slope of ˜5 cm⁻¹/V (FIG. 17). The underlaying 2DIR spectra diagonal slices as well as a representative 2DIR spectrum are displayed in FIG. 18 and FIG. 14 (top), respectively. It can be seen in FIG. 20 and FIG. 14 (bottom) that when the rough gold is directly deposited onto the ITO layer, Fano-lineshape distortion appears for FTIR and 2DIR spectra. Such distortion is observed when the broad plasmonic resonance becomes strong in the mid-IR as a result of interference between the plasmon resonance signals and the molecular resonance signals. Similar phenomena are observed in thin gold/platinum plasmonic layers on ITO and thicker (>8 nm) metal surfaces, likely a result of macroscopic conductance. Additionally, at the same average thickness if the deposition speed of the metal is raised, the film will become smoother and form more connections between the islands. This topology also results in a similar redshift in the plasmonic frequency and lineshape distortions. These observations suggest that the plasmonic resonance shifts into the IR when the metal islands are connected with each other, resulting in lower macroscopic resistance. The Al₂O₃ buffer layer developed here isolates the gold/platinum nano-islands from the conductive substrate, keeping the plasmonic resonance signal low, thereby reducing the lineshape distortion. However, the Al₂O₃ layer cannot be so thick that it completely insulates the plasmonic metal islands from the conductive ITO layer, rendering the electrode useless. We have found that a ˜3-5 nm Al₂O₃ layer works the best for this purpose while a thicker (>8 nm) layer will completely insulate the plasmonic metal layer from the ITO and yield no Stark shift when a voltage is applied.

Another interesting observation from the surface enhanced FTIR and 2DIR spectra is that the intensity of the vibrational transition also changes with the applied voltage. The 2DIR intensity is proportional to μ⁴, while linear IR intensity is proportional to μ², where μ is the transition dipole strength of the vibrational mode. We can calculate the relative transition dipole strength of the CN stretching mode by comparing spectra at different voltages. The transition dipole displays a linear relationship with the Stark shift (FIG. 19) which makes it an alternative indicator for the local electric field strength, Boxer and coworkers observed this relationship very recently with FTIR by switching the solvent, hence changing the solvent electric field. This suggests that we are directly changing the electronic structure of the molecule by applying a surface charge/electric field. The advantage of using peak intensity instead of frequency shift to indicate electric field strength is that it requires lower spectral resolution and generally yields better signal to noise when detector's intensity dynamic range is well utilized.

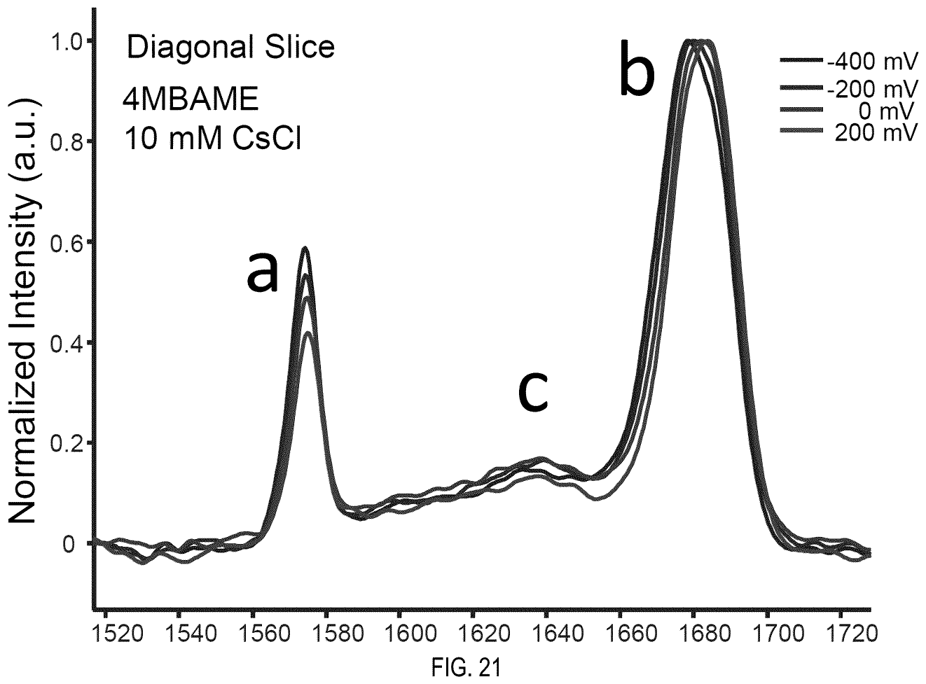

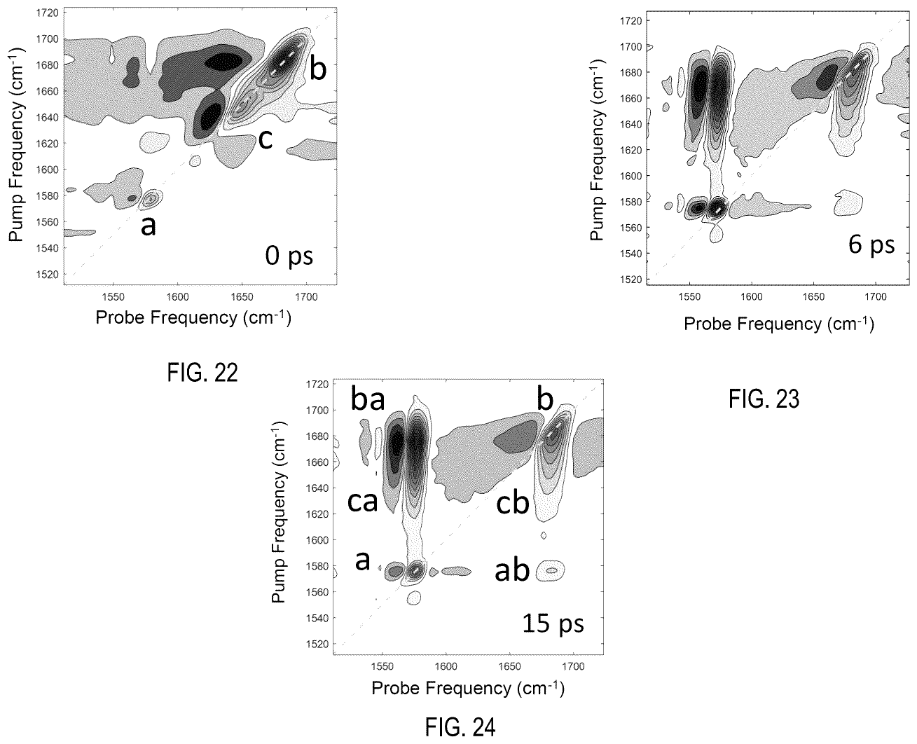

We further demonstrate the capability of the plasmonic substrates to probe cross-peak dynamics. A monolayer of 4-MBAME was prepared. The FTIR spectrum in air shows transitions including the asymmetric CO stretch (b in FIG. 21), ring C-C stretch (a in FIG. 21), and CH stretches ˜2900 cm⁻¹. The monolayer was then submerged in 10 mM KCl D₂O solution and assembled into the electrochemical cell for voltage experiments. The 2DIR spectrum has an additional peak (c in FIG. 21 and FIG. 22) which could be the water bending mode from the residual H₂O in the D₂O solution. To demonstrate again our ability to apply electric field at the interface, we applied various voltages to the working electrode. Upon applying the voltage, the asymmetric CO stretching mode Stark shifts at about 10 cm⁻¹/V whereas the CC stretching mode frequency is unchanged, likely due to small Stark tuning rate, as seen in the normalized diagonal slices of 2DIR spectra (FIG. 21).

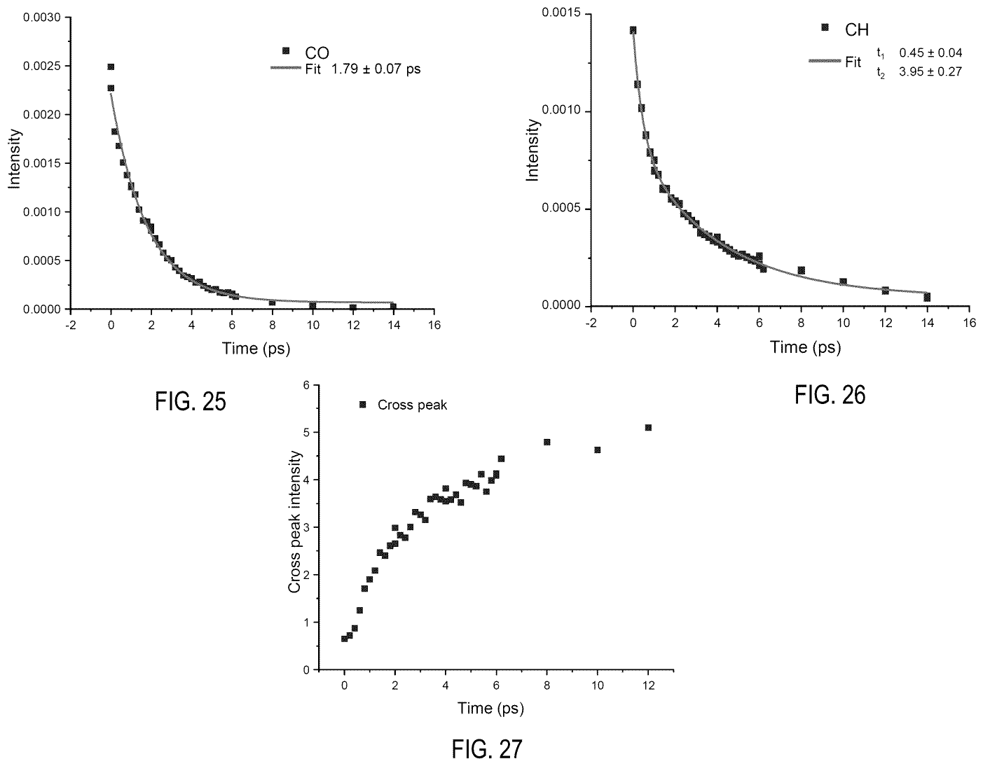

Having multiple transitions within the spectral range of the 2DIR spectrometer allows us to probe energy transfer dynamics within the molecules at the interface. The two strong transitions (the CC stretching mode and the CO stretching mode labeled as a and b respectively in FIG. 21) and the weaker transition (labeled as c in FIG. 21) have multiple cross peaks connecting them. Since a and b are two transitions of the same molecule, it is likely that the cross peaks between them are energy transfer cross peaks instead of chemical exchange cross peaks. These cross peaks (ab, cb, ba, ca in FIG. 23 and FIG. 24) become stronger relative to the diagonal peaks with increasing pump-probe waiting time, showcasing the ability to observe cross peak dynamics on interfacial molecules over a broad frequency range. We collected the intensities of the diagonal peaks and cross peaks as a function of delay time in FIG. 25, FIG. 26, and FIG. 27 under different voltages. The lifetimes and cross-peak dynamics do not change significantly from −400 mV to 200 mV relative to the Ag/AgCl leakless reference electrode. From this observation, we conclude that, at least for this molecule, intramolecular vibrational relaxation is unaffected by applied electric field.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed:

I/we claim:

1. A flow cell working electrode comprising a first layered structure, the first layered structure comprising:
a substrate;
a conductive electrode layer contacting the substrate;
an electrically resistive layer contacting the conductive electrode layer such that the conductive electrode layer is positioned between the substrate and the electrically resistive layer, the electrically resistive layer having an electrically resistive thickness tailored to reduce electrical conductivity across the electrically resistive layer but to allow an electric field associated with a voltage applied to the conductive electrode layer to be felt across the electrically resistive layer;
a macroscopically non-conductive plasmonic metal layer contacting the electrically resistive layer such that the electrically resistive layer is positioned between the conductive electrode layer and the macroscopically non-conductive plasmonic metal layer.

2. The flow cell working electrode of claim 1, the electrically resistive layer having an electrically resistive layer thickness of between 3 nm and 5 nm.

3. The flow cell working electrode of claim 1, the macroscopically non-conductive plasmonic metal layer having a plasmonic metal layer thickness of between 1 nm and 8 nm.

4. The flow cell working electrode of claim 1, the conductive electrode layer having a conductive electrode layer thickness of between 5 nm and 100 nm.

5. The flow cell working electrode of claim 1, wherein the conductive electrode layer is a semiconductor material layer.

6. The flow cell working electrode of claim 1, wherein the conductive electrode layer has an amorphous crystalline structure.

7. The flow cell working electrode of claim 1, wherein the macroscopically non-conductive plasmonic metal layer comprises a macroscopically non-conductive plasmonic metal layer material selected from the group consisting of Au, Pt, Ag, and combinations thereof.

8. The flow cell working electrode of claim 1, wherein applying light from a coherent or incoherent light source to the conductive electrode layer provides a surface-enhanced two-dimensional infrared or Fourier transform infrared spectroscopy surface on the macroscopically non-conductive plasmonic metal layer.

9. The flow cell working electrode of claim 1, wherein a portion of the flow cell working electrode comprises a second layered structure laterally adjacent to or laterally surrounding the first layered structure, the second layered structure comprising: the substrate; the conductive electrode layer; and a conductive metal layer contacting the conductive electrode layer.

10. The flow cell working electrode of claim 9, wherein the conductive metal layer laterally contacts the macroscopically non-conductive plasmonic metal layer.

11. The flow cell working electrode of claim 9, wherein the conductive metal layer has a thickness of between 10 nm and 1 μm.

12. The flow cell working electrode of claim 1, wherein applying the voltage to the conductive electrode layer produces an electric-field-applied surface.

13. The flow cell working electrode of claim 1, the conductive electrode layer having the voltage applied thereto, such that the electric field is felt at a surface of the macroscopically non-conductive plasmonic metal layer.

14. The flow cell working electrode of claim 13, wherein at least one beam of infrared light having a frequency of between 1500 cm⁻¹ and 3500 cm⁻¹ is incident the macroscopically non-conductive plasmonic metal layer.

15. A pair of flow cell electrodes in operable orientation relative to one another comprising the flow cell working electrode of claim 1 and a counter electrode.

16. A flow cell having a detection channel in fluidic communication with an inlet and an outlet, the detection channel including at least one of the flow cell working electrodes of claim 1 oriented to sense molecules of interest in the detection channel.

17. The flow cell of claim 16, the flow cell further comprising a counter electrode positioned within the detection channel.

18. A spectroscopic system comprising:
a light source;
an optical detector; and
the flow cell of claim 16 operably positioned in an optical path between the light source and the optical detector.

19. A method of making a flow cell working electrode, the method comprising:
a) depositing a conductive electrode layer onto a substrate;
b) depositing an electrically resistive layer onto the conductive electrode layer such that the conductive electrode layer is positioned between the substrate and the electrically resistive layer;
c) depositing a macroscopically non-conductive plasmonic metal layer onto the electrically resistive layer such that the electrically resistive layer is positioned between the conductive electrode layer and the macroscopically non-conductive plasmonic metal layer.

20. A method of using a flow cell working electrode comprising sequentially a substrate, a conductive electrode layer, an electrically resistive layer, and a macroscopically non-conductive plasmonic metal layer, the method comprising:
a) applying a first voltage to the conductive electrode layer;
b) during the applying of step a), acquiring an infrared spectrum of molecules of interest present at a surface of the macroscopically non-conductive plasmonic metal layer, the molecules of interest experiencing a first electric field associated with the first voltage;
c) applying a second voltage to the conductive electrode layer, wherein the second voltage is different than the first voltage;
d) during the applying of step c), acquiring an infrared spectrum of the molecules of interest, the molecules of interest experiencing a second electric field associated with the second voltage;
e) generate a report including field-dependent infrared spectra, wherein the field-dependent infrared spectra have a sufficiently low background signal to resolve an OH stretching mode, a CO stretching mode, a CN stretching mode, or a CH stretching mode.
